(19) United States
(12) Patent Application Publication
(10) Pub. No.: US 2018/0273279 A1
(43) Pub. Date: Sep. 27, 2018

(54) TICKET DISPENSER

(71) Applicant: Fastrak Retail (UK) Limited, Cheshire (GB)

(72) Inventors: Paul Shardlow, Cheshire (GB); Stephen Matthews, Cheshire (GB)

(21) Appl. No.: 15/764,721

(22) PCT Filed: Sep. 30, 2016
(86) PCT No.: PCT/GB2016/053054

§ 371 Date: Mar. 29, 2018

(30) Foreign Application Priority Data
Sep. 30, 2015 (GB) 1517317.2

(51) Int. Cl. B65D 83/12; G07B 3/04

(52) U.S. Cl. CPC B65D 83/12; B42D 5/00; B65D 2583/005; G07B 3/04

(57) ABSTRACT

A ticket dispenser for dispensing tickets from a ticket pack provided as a pleated ribbon of tickets, the ticket pack having opposed first and last tickets for dispensing first and last from the ticket dispenser, the dispenser comprising: a ticket rack comprising a ticket platen for receiving the ticket pack; a first ticket biasing mechanism and a second ticket biasing mechanism each having a first portion connected to the ticket rack and biased with respect to the ticket rack, and each having a respective second portion configured to bias against the ticket pack and towards the ticket platen, wherein the first ticket biasing mechanism and the second ticket biasing mechanism bias against opposed end portions of the ticket pack and a gap is provided between the first ticket biasing mechanism and the second ticket biasing mechanism for the loading of the ticket pack into ticket rack and the dispensing of tickets from the ticket rack.

### FIELD OF INVENTION

The present invention relates to a ticket dispenser for dispensing tickets from a ribbon of tickets formed into pleated pack, and more particularly, but not exclusively, to a ticket dispenser for dispensing a ribbon of scratch-card tickets.

### BACKGROUND

Ticket dispensers for dispensing tickets from a concertina-pleated ribbon that are suitable for mounting on a retail counter are known, and an example of such a ticket dispenser is disclosed in WO2013041858. However, there remains a need for a ticket dispenser having a small footprint, which may be conveniently fitted in a narrow supermarket checkout lane, for example.

### SUMMARY OF THE DISCLOSURE

According to an aspect of the present invention, there is provided a ticket dispenser for dispensing tickets from a ticket pack provided as a pleated ribbon of tickets, the ticket pack having opposed first and last tickets for dispensing first and last from the ticket dispenser, the dispenser comprising:
a ticket rack comprising a ticket platen for receiving the ticket pack;
a first ticket biasing mechanism and a second ticket biasing mechanism each having a first portion connected to the ticket rack and biased with respect to the ticket rack, and each having a respective second portion configured to bias against the ticket pack and towards the ticket platen,
wherein the first ticket biasing mechanism and the second ticket biasing mechanism bias against opposed end portions of the ticket pack and a gap is provided between the first ticket biasing mechanism and the second ticket biasing mechanism for the loading of the ticket pack into ticket rack and the dispensing of tickets from the ticket rack.

The ticket rack may be configured to receive the ticket pack with the tickets orientated parallel to the ticket platen.

A ticket biasing mechanism may comprise a band of resiliently deformable material that is connected to the ticket rack and projects towards the other ticket biasing mechanism.

Each band of resiliently deformable material may curve in a loop connected to the ticket rack, with an intermediate portion along the length of the loop that projects towards the other ticket biasing mechanism and that is biased towards the ticket platen.

Each band may be curved into a loop with a free end that biases against the ticket rack.

The first and second ticket biasing mechanisms may each comprise a band of resiliently deformable material that is connected to the ticket rack and projects towards the other ticket biasing mechanism, the first and second biasing mechanisms further comprising a dispensing lock configured to connect together the first and second ticket biasing mechanisms.

The dispensing lock may comprise a hook and a hook receiving slot, the hook being connected to the band of the first ticket biasing mechanism, the hook receiving slot being provided in the band of the second ticket biasing mechanism, wherein the dispensing lock is configurable into a locked position in which the hook is engaged within the hook receiving slot.

A ticket biasing mechanism may comprise an arm that is pivotally connected to the ticket rack and has a free end that is biased towards the ticket platen. The free end may be biased towards the ticket platen by a spring mechanism.

A roller may be rotatably connected to the arm and the ticket biasing mechanism may be configured to bias the roller towards the ticket platen.

The ticket rack may comprise
a main body section, and
ticket alignment brackets having ticket alignment faces for aligning the ticket pack on
the ticket platen between the ticket alignment faces.

A ticket alignment bracket may be adjustably connected to the main body section, being configured to adjust the separation between the ticket alignment faces.

A ticket biasing mechanism may be connected to a ticked alignment bracket.

The ticket platen may be transparent or comprise a transparent window for viewing at least part of a ticket loaded against the ticket platen.

The ticket dispenser may comprise a security cover connected to the rack for substantially enclosing the ticket pack between the rack and the cover.

The security cover may comprise a rollable screen and a spindle that are configured to move between:
an open configuration in which the screen is rolled around the spindle, and
a closed configuration in which the screen is unrolled with a first end of the screen connected to the spindle and the opposed second end of the screen mechanically engageable with a retention mechanism for retaining the screen in the closed configuration.

### BRIEF DESCRIPTION OF THE DRAWINGS

Exemplary ticket dispensers according to the invention are further described hereinafter with reference to the accompanying drawings, in which:

FIG. 1A shows a rear, retailer-facing view of the ticket dispenser, and FIG. 1B shows an enlarged view of portion indicated by X in FIG. 1A;

FIG. 1C shows a front, customer-facing view of the ticket dispenser of FIG. 1A;

FIG. 1D shows an exploded view of the ticket dispenser of FIG. 1A;

FIG. 1E shows a side view of the ticket dispenser of FIG. 1A, and FIG. 1F shows an enlarged view of portion Y in FIG. 1E;

FIG. 1G shows a cut-away side view of the ticket dispenser of FIG. 1A that has been loaded with a concertina-pleated ribbon of tickets;

FIG. 2A shows a perspective view a further ticket dispenser having a dispensing lock;

FIG. 2B shows a perspective view of a hook from the dispensing lock of FIG. 2A;

FIG. 2C shows a plan view of the retailer-facing face of the ticket dispenser of FIG. 2A;

FIGS. 2D and 2E show cut-away side views of the ticket dispenser of FIG. 2A, loaded for use with a pleated ribbon ticket pack, with the dispensing lock, respectively, in the locked and unlocked positions;

FIG. 2F shows an enlarged view of the upper part of FIG. 2E; and

FIG. 2G and 2H show cut-away side views of the ticket dispenser of FIG. 2A, loaded for use with a pleated ribbon ticket pack, each with a first ticket that is partially withdrawn from the ticket pack.

### DETAILED DESCRIPTION

In the described embodiments, like features have been identified with like numerals, albeit in some cases having one or more of: increments of 100; and typographical marks (e.g. primes). For example, in different figures, 190, 290 and 290′ have been used to indicate a ticket pack.

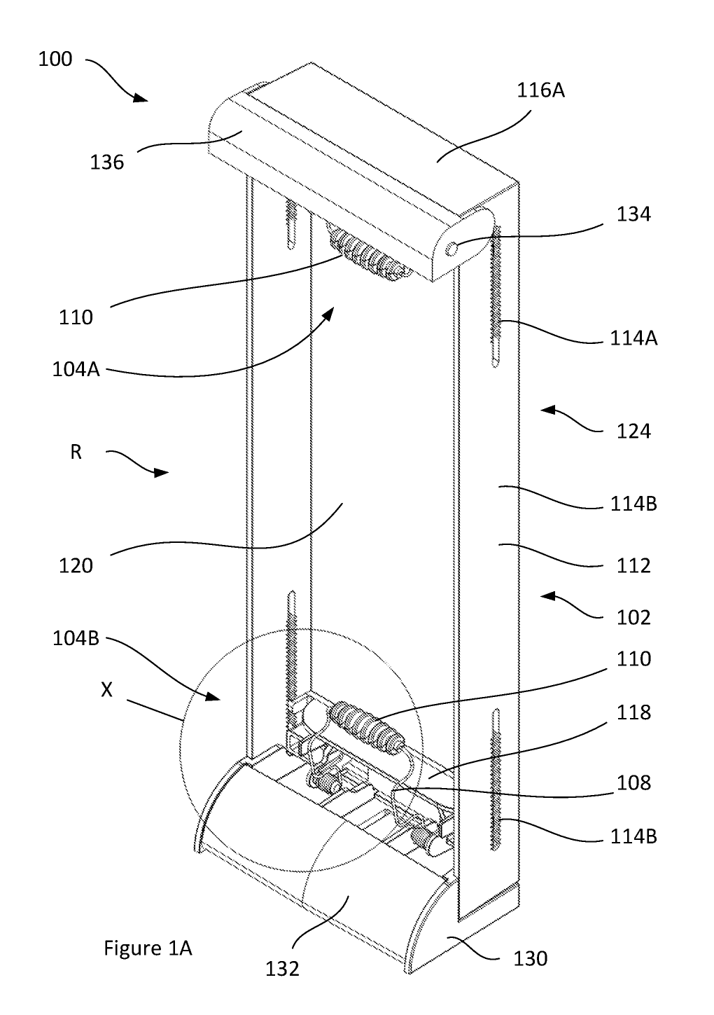

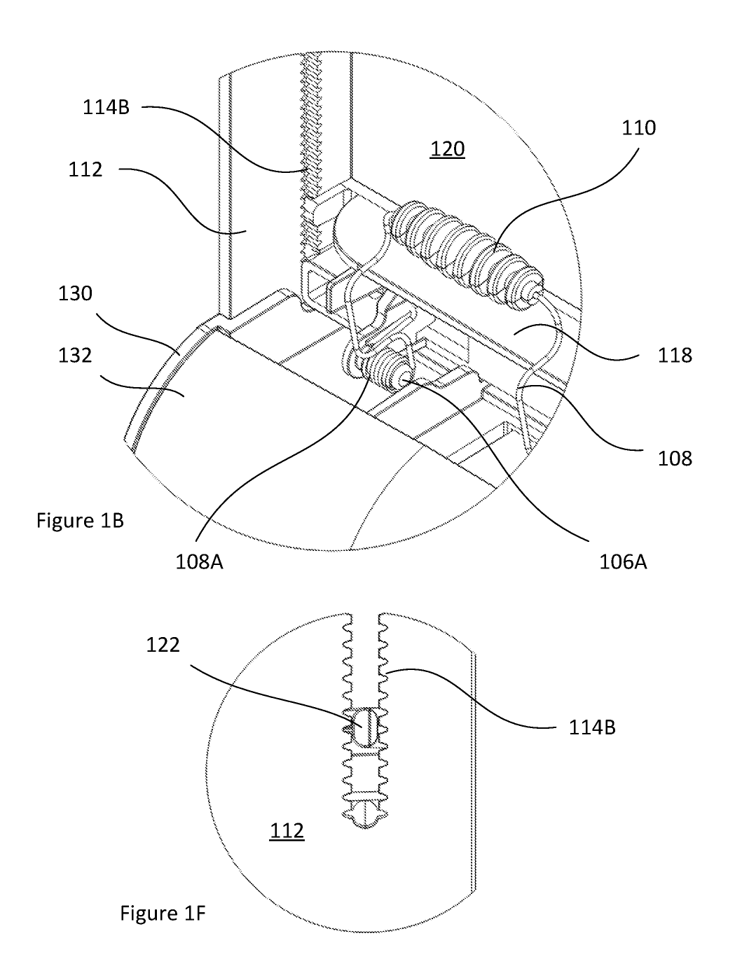

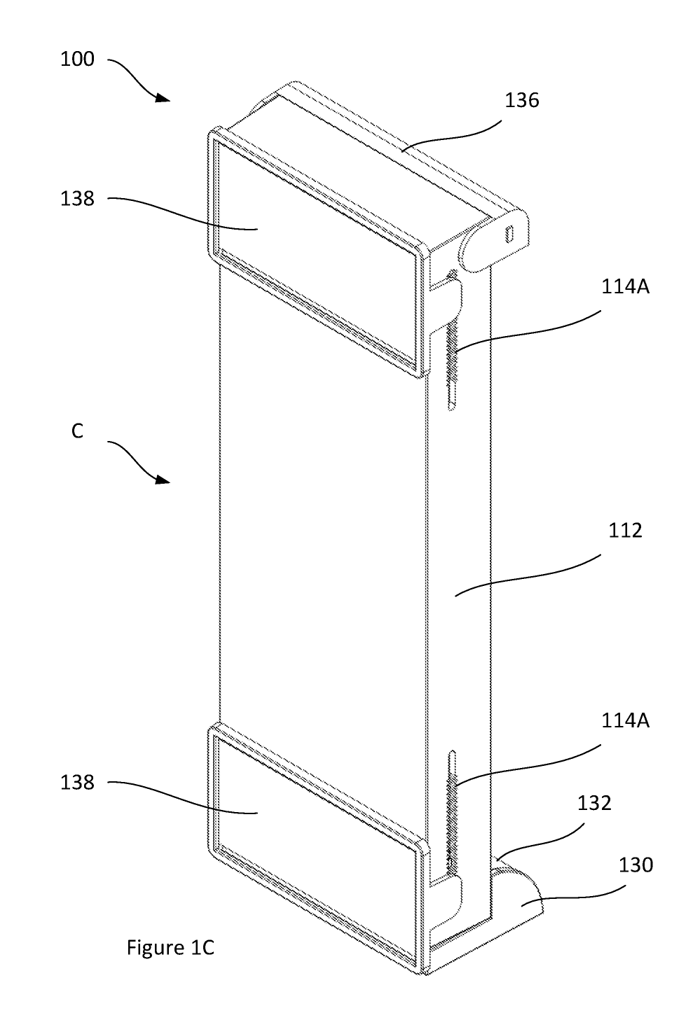

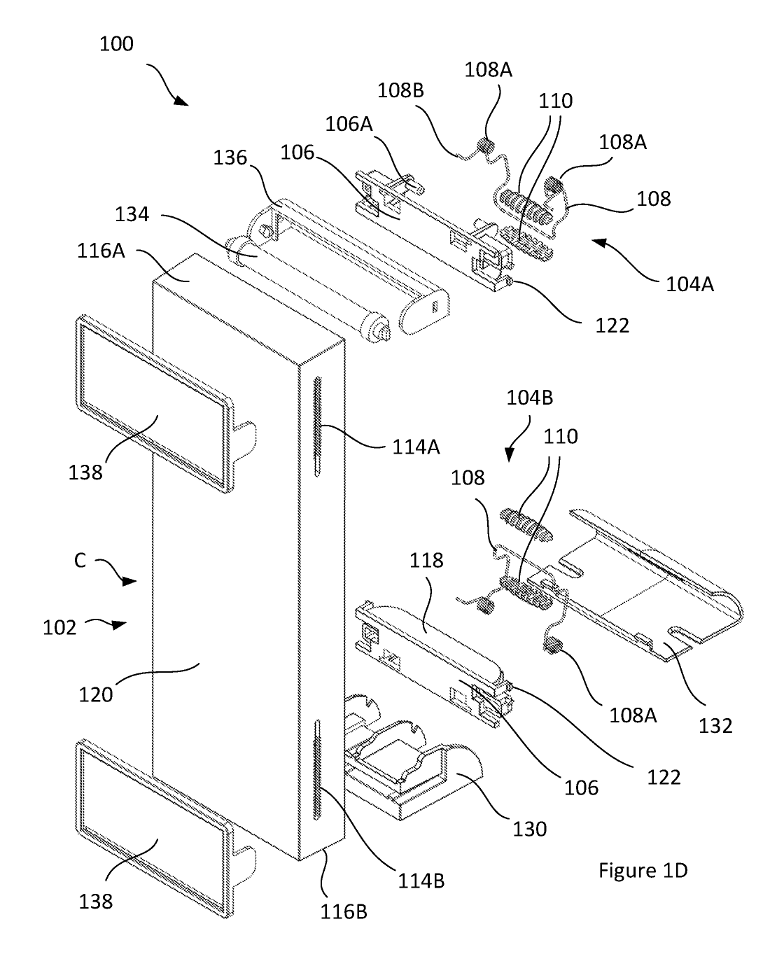

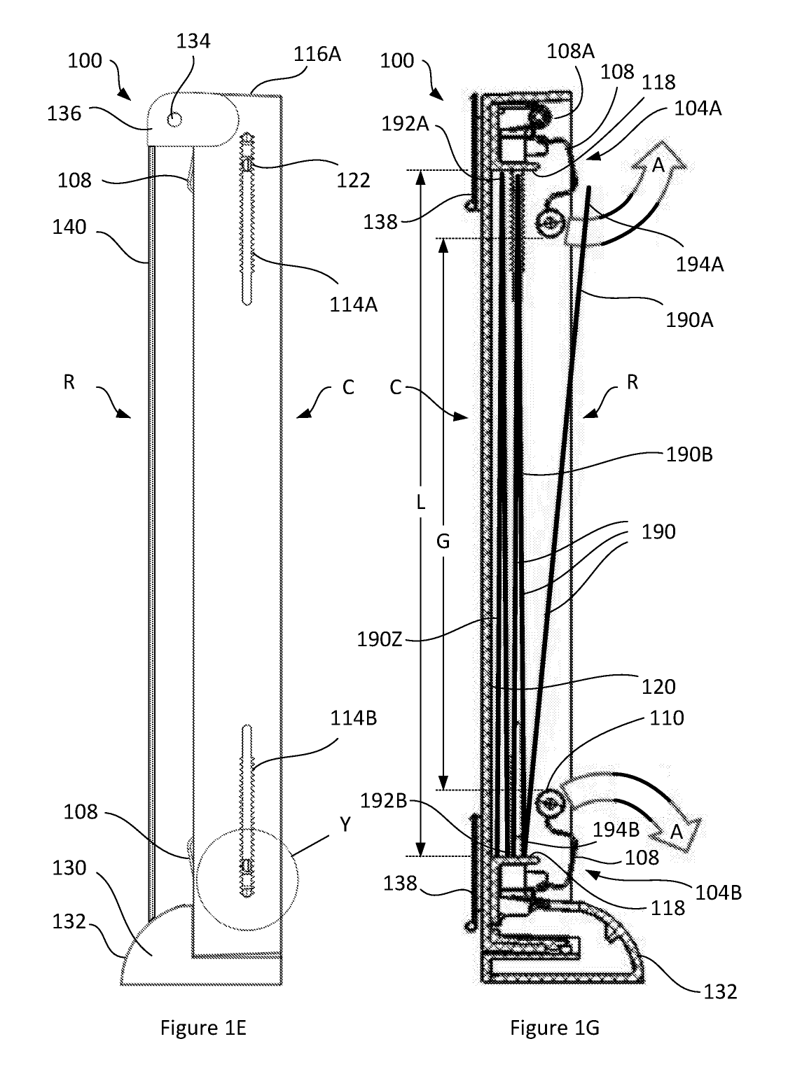

FIG. 1A shows a perspective view of the retailer-facing face R of a ticket dispenser 100, and FIG. 1B shows an enlarged view of the portion indicated by X. FIG. 10 shows a view of the opposed customer-facing face C of the ticket dispenser 100. FIG. 1D shows an exploded view of the ticket dispenser 100. FIG. 1E shows a side view of the ticket dispenser 100, and FIG. 1F shows an enlarged view of the portion indicated by Y. FIG. 1G shows a cut-away side view of the ticket dispenser 100 in use, loaded with a ticket pack 190 formed as a pleated ribbon.

The ticket dispenser 100 comprises a ticket rack 102 and first and second ticket biasing mechanisms 104A and 104B, and a gap G between the ticket biasing mechanisms through which tickets can be dispensed. A gap G is present in the rest state of the ticket dispenser 100, being maintained across the range of fill-statuses, i.e. ranging from maximally filled with tickets to empty. The gap G extends across the width of the ticket rack 102. During dispensing, a ticket 190A (e.g. a semi-rigid cardboard ticket) may remain substantially flat across its width, curving outwardly away from the ticket pack 190.

The ticket rack 102 comprises a shallow, elongate box-like main body 124 that is open on the retailer-facing face R of the ticket dispenser 100 (in the absence of a closed cover, e.g. a rollable security cover or hinged lid), and which is provided with a ticket platen 120 for receiving a pack of tickets 190 in the form of a pleated ribbon. The ticket rack 102 further comprises carriers (ticket alignment brackets) 106 upon which the ticket biasing mechanisms 104A and 104B are mounted.

Each ticket biasing mechanism 104A and 104B comprises a sprung arm 108 that is pivotally connected to the carrier 106, and a roller 110 that is rotatably mounted on the end of the sprung arm (FIG. 1D shows an exploded view of the rollers 110 as two parts for assembly around each sprung arm 108). As is shown more clearly in FIG. 1B, the sprung arms 108 each comprise a pair of torsion springs 108A, which engage lugs 106A on the carriers, and ends 108B of the sprung arms bias against further features of the carriers. Accordingly, the main part of the sprung arm 108 is pivotably connected to the carrier 106, and by biasing against the carrier that sprung arm biases the roller 110 on the other end of the sprung arm towards the ticket platen 120. Accordingly, in use with a pleated ribbon ticket pack 190, the rollers 110 press upon the ticket pack proximate respective end 192A and 192B of the ticket pack, to hold the ticket pack against the ticket platen 120. It will be appreciated that alternatively, one or both of the sprung arms 108 could be pivotably mounted on the box-like main body 124 or another fixture on the main body 124 (and biased with respect to the box-like main body), rather than being mounted on the carriers 106 of the illustrated ticket dispenser 100.

The carriers 106 are adjustably connected to the sides 112 of the box-like main body 124, proximate to the ends 116A and 116B of the main body. The sides 112 of the box-like main body 124 are each provided with slots 114A and 114B into which the carriers 106 are engageable. The carriers 106 have respective ticket alignment faces 118, between which the ticket pack 190 is aligned on the ticket platen 120, in use. The separation L between the ticket alignment faces 118 may be adjusted to adapt the ticket dispenser 100 to receive different lengths of ticket pack 190.

In the illustrated ticket dispenser 100, the ticket rack 102 is formed from a transparent plastics material, such that the ticket 190Z that is presented against the ticket platen 120, in use, is displayed through the ticket platen to a customer at the customer-facing face C of the ticket dispenser. Alternatively, just the ticket platen 120, or a viewing window in the ticket platen, may be transparent.

In use, a ticket pack 190, being a ribbon of tickets folded to form a concertina-like pleated pack of tickets (also referred to as fan-folded) is loaded into the ticket dispenser 100. To load the ticket pack 190 into the ticket dispenser 100, the sprung arms 108 are pivoted away from the ticket platen 120, as indicated by the arrows A in FIG. 1G, enabling the ticket pack to be inserted against the ticket platen, between the ticket alignment faces 118 (further ticket alignment features may be provided extending along the sides 112 of the ticket rack 102, if required), with the tickets orientated parallel to the ticket platen. The ticket pack 190 is loaded with the free end 194A of the first ticket 190A extending out through the gap G between the ticket biasing mechanisms 104A and 104B. Once the ticket pack 190 has been loaded into the ticket dispenser 100, the sprung arms 108 are released and the sprung arms bias the ticket pack (apart from the free end 194A of the first ticket 190A) against the ticket platen 120. Advantageously, the biasing of the sprung arms 108 against the carriers 106 (or against the ticket dispenser 100 holds the ticket pack 190 against the ticket platen 120, whilst enabling tickets to be conveniently withdrawn from within the ticket dispenser. Holding the ticket pack 190 against the ticket platen 120 with the biasing force of the sprung arms 108, enables the ticket dispenser 100 to be used in different orientations, e.g. with a pack of cardboard tickets stood on end (aligned vertically) as shown in the FIG. 1G. The tickets 190 are semi-rigid, being sufficiently structural to maintain their shape when stood on end (as illustrated), and are resiliently deformable during dispensing, enabling them to bend outwardly away from the ticket platen 120, whilst remaining substantially flat across their width.

To dispense a ticket, the first ticket 190A is fully withdrawn through the gap G between the ticket biasing mechanisms 104A and 104B, from within the ticket dispenser 100. The roller 110 that bears onto the ticket pack 190 adjacent the opposite end 194B of the first ticket 190A rotates as the first ticket is withdrawn, and the second ticket 190B resiliently deformably buckles gently along its length as the end that is connected to the first ticket is drawn away from the end 192B of the ticket pack 190, and out through the gap G. Advantageously the rollers 110 reduce the risk of abrasive contact to the faces of the tickets 190A and 190B, as the tickets are withdrawn from beneath the ticket biasing mechanisms 104A and 104B, which reduces the risk of damage to tickets, e.g. reducing the risk of damage to any sensitive panels, in the case that the tickets are scratch-cards. The first and second tickets 190A and 190B require space in which to bend as the first ticket is withdrawn: advantageously the open face on the retailer-facing face R of the ticket rack 102 may enable this bending to occur partially outside of the ticket rack, thereby advantageously enabling the ticket rack to be shallower in depth than would be required for a closed ticket dispenser.

The biasing mechanisms 104A and 104B adjustably connect to the ticket rack 102 by projections 122 of the carriers 106, which detachably engage in respective slots 114A and 114B of the ticket rack 102. The slots 114A and 114B have serrated edged, such that projections 122 of the carriers 106 can securely engage with the slots, as is shown more clearly in FIG. 1F. Advantageously, to accommodate different sizes of ticket within the ticket dispenser, the separation between the ticket biasing mechanisms 104A and 104B may be adjusted (so adjusting the separation between the ticket alignment faces 118, in the illustrated ticket dispenser 100), by disconnecting one or both of the carriers 106 from the rack 102, moving the carriers along the slots 114A and 114B and reconnecting to the ticket rack. Alternatively, the ticket biasing mechanisms 104A and 104B may be non-adjustably connected to the ticket rack 102.

The ticket dispenser 100 also comprises a foot 130 and a retail counter base 132, and graphics holders 138 (shown only in FIGS. 1C, 1D and 1G). The ticket dispenser 100 also comprises a spindle 134, a spindle bracket 136, and a rollable screen 140 that may serve as a security cover (these elements are only shown in FIG. 1E).

In use on a retail counter, the base 132 may be secured to the retail counter: the foot 130 is secured to the ticket rack 102, and the foot 130 detachably connects to the retail counter.

Accordingly, the ticket rack 102 and the pack of tickets 190 may be conveniently removed from the retail counter, by detaching the foot 130 from the base 132. A lock mechanism (not shown) may be provided to lock the foot 130 to the counter base 132. Alternatively, the ticket dispenser 100 may be mounted to a transparent upright face of a counter retail, with the ticket platen 120 against the upright face, so that the ticket 190Z at the end of the ticket pack 190 is displayed through the upright face of the retail counter.

In the open position, the rollable screen 140 is mostly rolled around the spindle 134. To secure the ticket pack within the ticket dispenser 100, the screen 140 is unrolled, and its lower end is engaged with the foot 130 to enclose the ticket pack 190. A lock (not shown) may additionally be provided to lock the screen 140 in the closed position.

The graphics holders 138 clip into the slots 114A and 114B, and may display information about the tickets 190 held within the ticket dispenser 100.

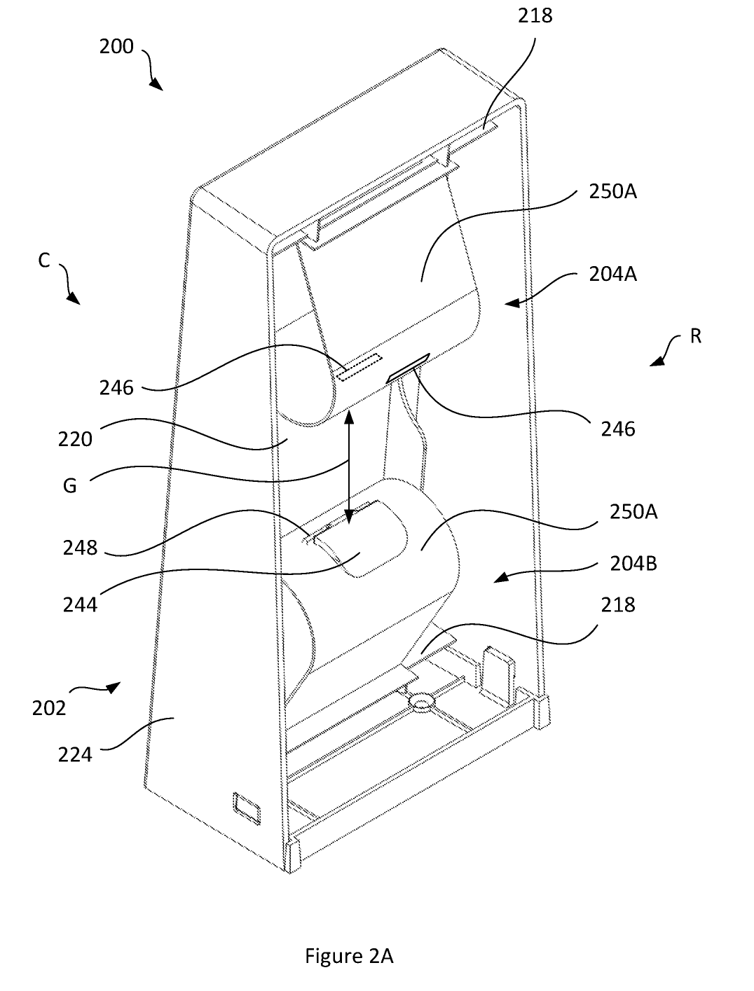

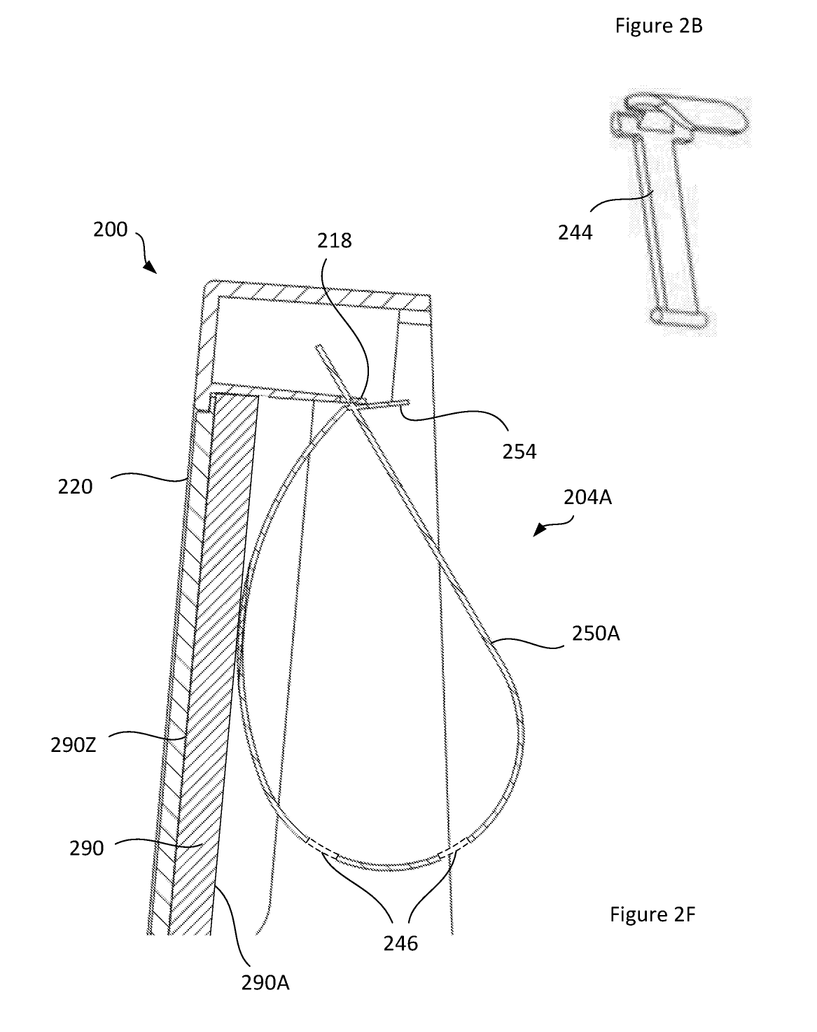

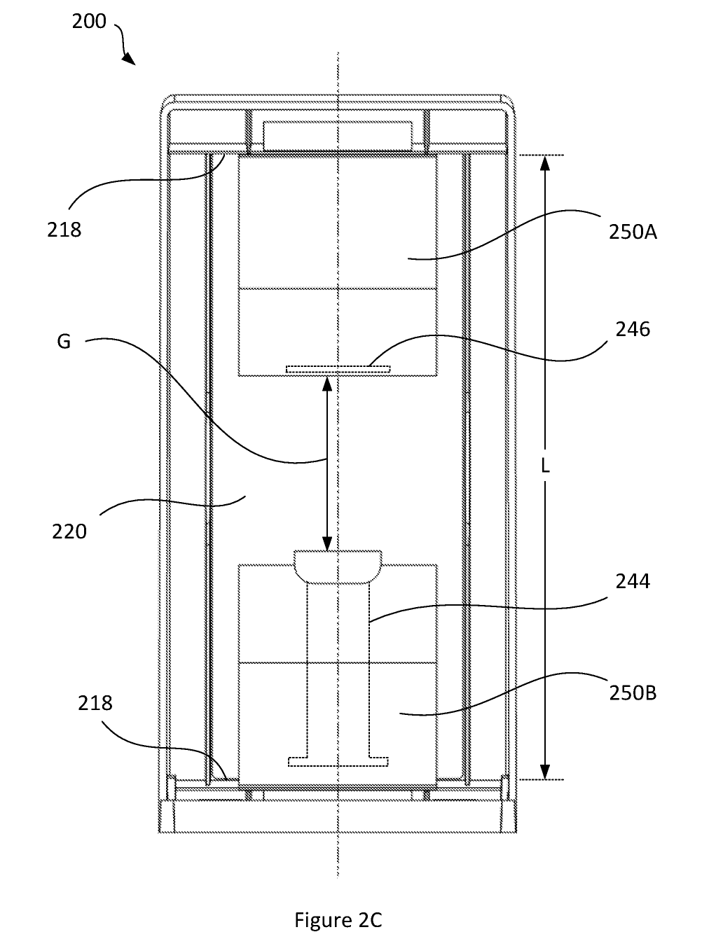

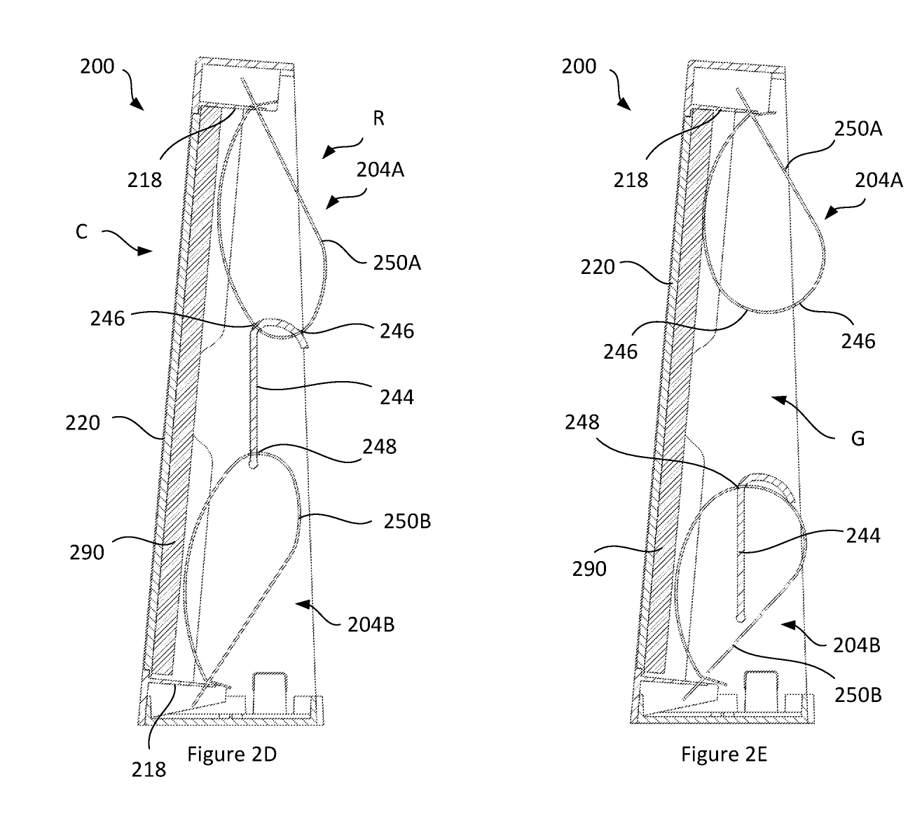

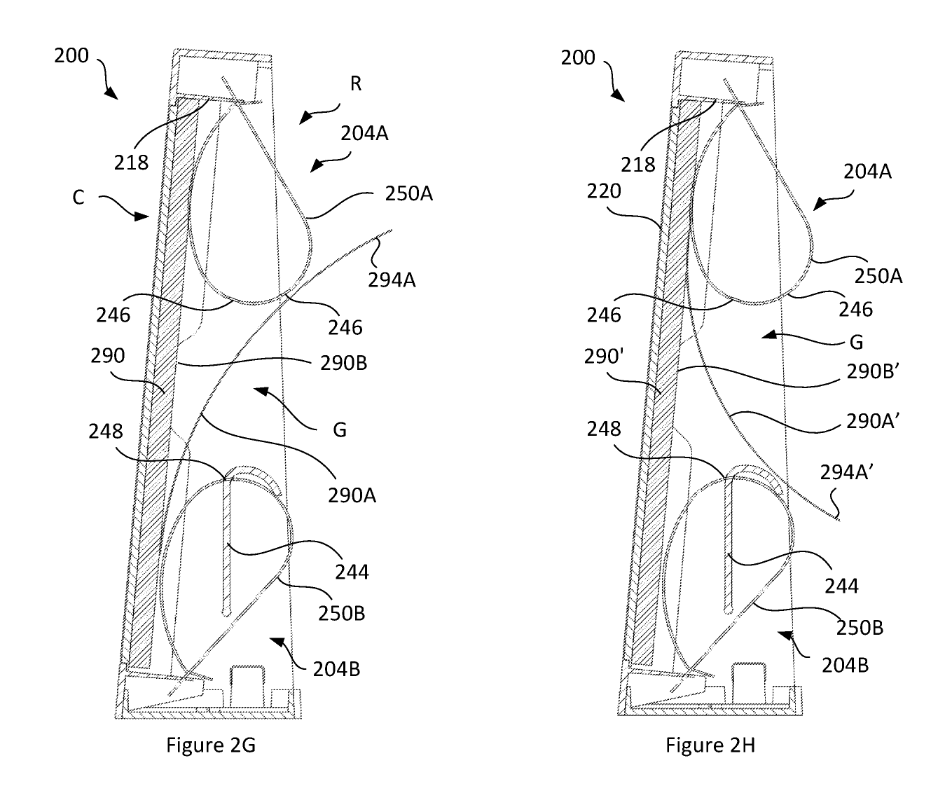

FIG. 2A shows a perspective view of the retailer-facing face R of a further ticket dispenser 200, having a dispensing lock with a hook member 244, which is shown in an enlarged perspective view in FIG. 2B. FIG. 2C shows a plan view of the retailer-facing face R of the ticket dispenser 200. FIGS. 2D and 2E show cut-away side views of the ticket dispenser 200, loaded for use with a concertina-folded (pleated) ribbon ticket pack 290, with the dispensing lock, respectively, in the locked and unlocked positions. FIG. 2F shows an enlarged view of the upper part of FIG. 2E. FIGS. 2G and 2H show cut-away side views of the ticket dispenser 200, loaded for use with a pleated ribbon ticket pack 290 and 290′, with a first ticket 290A and 290A′ that is partially withdrawn from the ticket pack.

The ticket dispenser 200 comprises a ticket rack 202 and first and second ticket biasing mechanisms 204A and 204B, with a gap G between the ticket biasing mechanisms through which tickets can be dispensed. A gap G is present in the rest state of the ticket dispenser 200, being maintained across the range of fill-statuses, i.e. ranging from maximally filled with tickets to empty. The gap G extends across the width of the ticket rack 202 to enable tickets 290A to remain substantially flat across their width during dispensing. The ticket dispenser 200 of FIGS. 2A to 2H is similar to the ticket dispenser 100 of FIGS. 1A to 1G, primarily differing by the design of the ticket biasing mechanisms 204A and 204B.

The ticket rack 202 comprises a shallow, elongate box-like main body 224 that is open on the retailer-facing face R of the ticket dispenser 200, and which comprises a ticket platen 220 for receiving a pack of tickets 290 in the form of a pleated ribbon. The ticket rack 202 comprises ticket alignment faces 218, between which the ticket pack 290 is aligned on the ticket platen 220, in use. The ticket biasing mechanisms 204A and 204B are biased against the ticket alignment faces 218, to which the ticket biasing mechanisms are connected.

Each ticket biasing mechanism 204A and 204B comprises a band 250A and 250B of resiliently deformable material connected to the ticket rack 202 adjacent opposite ends of a ticket pack 290, in use, which extend inwardly towards the other ticket biasing mechanism, and which are biased towards the ticket platen 220, by their reaction against the ticket alignment faces 218. The bands 250A and 250B of the ticket biasing mechanisms 204A and 204B are formed as loops, having a projecting free end 254 that biases against the ticket rack 202, which biases the loop towards the ticket platen 220. The opposite ends of the looped bands 250A and 250B cross in a tongue and slot arrangement. As shown in FIG. 2F, in the illustrated ticket dispenser 200, the free end 254 biases against the respective ticket alignment faces 218 of the ticket rack 202, which biases the looped band 250A towards the ticket platen 220, and against the ticket pack 290 in use. Alternatively, the bands 250A and 250B may be connected to and bias against a different part of the ticket rack 202.

In the illustrated ticket dispenser 200, the ticket biasing mechanisms 204A and 204B and the ticket alignment faces 218 are fixed to the main body 224. However, the ticket alignment faces may be adjustably connected to the main body 224, to enable adjustment of the separation L between the ticket alignment faces 218 for differently sized tickets 290. Alternatively, or additionally, the gap G between the ticket biasing mechanisms 204A and 204B may also be adjustable independently of the separation L between the ticket alignment faces 218. The adjustment may be provided by use of adjustable carriers (ticket alignment brackets) having the ticket alignment faces 218 and to which the ticket biasing mechanisms 204A and 204B are mounted, in a similar arrangement to the ticket dispenser 100 of FIG. 1A.

A hindrance to unauthorised ticket dispensing is advantageously provided by the optional dispensing lock, which is configured to connect between the first and second ticket biasing mechanisms 204A and 204B, obstructing the intervening gap G through which tickets are dispensed, in use. In the illustrated ticket dispenser 200, the dispensing lock is provided by a hook 244 and slot 246 arrangement.

The hook 244 has a curved end portion 244A, a stem 244B and a T-bar 244C at the opposite end. The stem 244B is engaged within an anchoring slot 248 in the looped band 250B of the second ticket biasing mechanism 204B. In the locked position, shown in FIG. 2D, the hook 244 is extended from within the looped band 250B, and the curved portion 244A of the hook is hooked into the hooking slot 246 provided in the looped band 250A of the first ticket biasing mechanism 204A. This hooking engagement 244, 246 clips together the first and second ticket biasing mechanisms 204A and 204B, with the hook 244 obstructing dispensing through the gap G between the ticket biasing mechanisms 204A and 204B. Advantageously, the hook 244 and bands 250A and 250B are sized to require a modest deformation of the resiliently deformable looped band 250B to enable hooking engagement with the hooking slots 246, providing a tension that holds the hook in place within the hooking slots 246.

FIG. 2E shows the ticket dispenser in the unlocked position, with the hook 244 being retracted within the looped band 250B of the second ticket biasing mechanism 204B. In the unlocked position, tickets 290A and 290A′ may be dispensed through the gap G between the ticket biasing mechanisms 204A and 204B, as is shown in FIGS. 2G and 2H.

In the illustrated ticket dispenser 200, the ticket rack 202 is formed from a transparent plastics material, such that the ticket 290Z that is against the ticket platen 220 can be seen through the ticket platen by a customer at the customer-facing face C of the ticket dispenser, in use. Alternatively, just the ticket platen 220, or a window in the ticket platen, may be transparent.

In use, a ticket pack 290 formed as a concertinaed pleated ribbon of tickets is loaded into the ticket dispenser 200. To load the ticket pack 290 into the ticket dispenser 200, the looped bands 250A and 250B are drawn away from the ticket platen 220, enabling the ticket pack to be inserted against the ticket platen, between the ticket alignment faces 218. Once the ticket pack 290 has been loaded into the ticket dispenser 200, the looped bands are released and bias the ticket pack 290 against the ticket platen 220.

Although the ticket biasing mechanisms 204A and 204B of the ticket dispenser 200 are shown connected to a fixed part of the ticket rack 202, alternatively one or both of the ticket biasing mechanisms may be adjustably connected to the ticket rack, for example being connected to an adjustable carrier, as shown in the ticket dispenser 100 of FIGS. 1A to 1G, advantageously enabling the ticket dispenser 200 to be adjusted for tickets of different lengths. However, advantageously, the ticket biasing mechanisms 204A and 204B bias against the ticket pack 290 adjacent to, but spaced apart from, the ticket alignment faces 218, enabling tickets to be dispensed from ticket packs having lengths within a small range.

As shown in FIG. 2G, to dispense a ticket, the free end 294A of the first ticket 290A is withdrawn from the ticket dispenser 200, through the gap G between the ticket biasing mechanisms 204A and 204B. The looped band 250B bears against the first ticket 290A, near the opposite end 294B, as the ticket is withdrawn, and the second ticket 290B resiliently deformably curves (buckles) gently along its length (not shown) as its corresponding end is drawn away from the end 292B of the ticket pack 290. Advantageously the biasing force of the second ticket biasing mechanisms 204B is distributed across the smooth surface of the band 250B, which reduces the risk of abrasion to the faces of the tickets 290A and 290B as they are withdrawn, which reduces the risk of damage to tickets, e.g. reducing the risk of damage to any sensitive panels, in the case that the tickets are scratch-cards. The first and second tickets 290A and 290B require space in which to bend as the first ticket is withdrawn: advantageously the open face on the retailer-facing face R of the ticket rack 202 enables this bending to occur partially outside of the ticket rack, thereby enabling the ticket rack to be shallower in depth than for a closed ticket dispenser.

Although not show, the ticket dispenser 200 may additionally be provided with a foot, a counter base, a spindle, a spindle bracket, a rollable screen (security cover), a screen lock, and graphics holders, as described with respect to the ticket dispenser 100 of FIGS. 1A to 1G.

Although in the illustrated ticket dispensers 100 and 200, the ticket platen has been shown as a flat plate, it will be appreciated that in an alternative design, the ticket platen may be curved, e.g. being bowed outwardly away from the open retailer-facing face R. Advantageously, being bowed outwardly may provide a more prominent view of part of the ticket to a customer, e.g. in the case that each pleat of the pleated ribbon pack of tickets comprises two serially connected tickets, the bowing may provide a more prominent view of one ticket from each pleat.

A ticket dispenser is provided for dispensing tickets from a ticket pack provided as a pleated ribbon of tickets, the ticket pack having opposed first and second ticket pack ends, and the ticket pack having opposed first and last tickets for dispensing first and last from the ticket dispenser, the dispenser comprising: a ticket rack comprising a ticket platen for receiving the ticket pack; a first ticket biasing mechanism configured to bias the first end of the ticket pack towards the ticket platen; and a second ticket biasing mechanism configured to bias the second end of the ticket pack towards the ticket platen.

The figures provided herein are schematic and not to scale.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A ticket dispenser for dispensing tickets from a ticket pack provided as a pleated ribbon of tickets, the ticket pack having opposed first and last tickets for dispensing first and last from the ticket dispenser, the dispenser comprising:
a ticket rack comprising a ticket platen for receiving the ticket pack;
a first ticket biasing mechanism and a second ticket biasing mechanism each having a first portion connected to the ticket rack and biased with respect to the ticket rack, and each having a respective second portion configured to bias against the ticket pack and towards the ticket platen,
wherein the first ticket biasing mechanism and the second ticket biasing mechanism bias against opposed end portions of the ticket pack and a gap is provided between the first ticket biasing mechanism and the second ticket biasing mechanism for the loading of the ticket pack into ticket rack and the dispensing of tickets from the ticket rack.

2. The ticket dispenser according to claim 1, wherein at least one of the first and the second ticket biasing mechanisms comprise a band of resiliently deformable material that is connected to the ticket rack and projects towards the other ticket biasing mechanism.

3. The ticket dispenser according to claim 2, wherein each band of resiliently deformable material curves in a loop connected to the ticket rack, with an intermediate portion along the length of the loop that projects towards the other ticket biasing mechanism and that is biased towards the ticket platen.

4. The ticket dispenser according to claim 3, wherein each band is curved into a loop with a free end that biases against the ticket rack.

5. The ticket dispenser according to claim 1, wherein the first and second ticket biasing mechanisms each comprise a band of resiliently deformable material that is connected to the ticket rack and projects towards the other ticket biasing mechanism, the first and second biasing mechanisms further comprising a dispensing lock configured to connect together the first and second ticket biasing mechanisms.

6. The ticket dispenser according to claim 5, wherein the dispensing lock comprises a hook and a hook receiving slot,
the hook being connected to the band of the first ticket biasing mechanism,
the hook receiving slot being provided in the band of the second ticket biasing mechanism,
wherein the dispensing lock is configurable into a locked position in which the hook is engaged within the hook receiving slot.

7. The ticket dispenser according to claim 1, wherein at least one of the first and the second ticket biasing mechanisms comprise an arm that is pivotally connected to the ticket rack and has a free end that is biased towards the ticket platen.

8. The ticket dispenser according to claim 7, wherein a roller is rotatably connected to the arm and at least one of the first and the second ticket biasing mechanisms is configured to bias the roller towards the ticket platen.

9. The ticket dispenser according to claim 1 wherein the ticket rack comprises
a main body section, and
ticket alignment brackets having ticket alignment faces for aligning the ticket pack on the ticket platen between the ticket alignment faces.

10. The ticket dispenser according to claim 9, wherein a ticket alignment bracket is adjustably connected to the main body section, being configured to adjust the separation between the ticket alignment faces.

11. The ticket dispenser according to claim 9, wherein at least one of the first and the second ticket biasing mechanisms is connected to a ticket alignment bracket.

12. The ticket dispenser according to claim 1, wherein the ticket platen is transparent or comprises a transparent window for viewing at least part of a ticket loaded against the ticket platen.

13. The ticket dispenser according to claim 1, comprising a security cover connected to the rack for substantially enclosing the ticket pack between the rack and the cover.

14. The ticket dispenser according to claim 13, wherein the security cover comprises a rollable screen and a spindle that are configured to move between:
an open configuration in which the screen is rolled around the spindle, and
a closed configuration in which the screen is unrolled with a first end of the screen connected to the spindle and the opposed second end of the screen mechanically engageable with a retention mechanism for retaining the screen in the closed configuration.

15. (canceled)
